(19) United States
(12) Patent Application Publication
(10) Pub. No.: US 2019/0147401 A1
(43) Pub. Date: May 16, 2019

(54) SYSTEM AND METHOD FOR AUTOMATED PACKAGE DELIVERY TO DYNAMIC LOCATIONS

(71) Applicant: Flytrex Aviation Ltd., Tel Aviv (IL)

(72) Inventors: Yariv BASH, Tel Aviv (IL); Amit REGEV, Tel Aviv (IL)

(73) Assignee: Flytrex Aviation Ltd., Tel Aviv (IL)

(21) Appl. No.: 16/186,731

(22) Filed: Nov. 12, 2018

Related U.S. Application Data
(60) Provisional application No. 62/584,956, filed on Nov. 13, 2017.

(51) Int. Cl. G06Q 10/08; B64C 39/02; G05D 1/10; G01S 19/42

(52) U.S. Cl. CPC G06Q 10/08355; B64C 39/024; G05D 1/101; B64C 2201/145; B64C 2201/128; B64C 2201/027; G01S 19/42

(57) ABSTRACT

A system and method for package delivery to a dynamic location. The method includes: receiving package information of a package, where the package information includes at least a user identifier; receiving location information from a user device associated with the user identifier; and sending navigation instructions to an automated delivery vehicle for delivery of the package based on the received location information.

### CROSS-REFERENCE TO RELATED APPLICATIONS

This application claims the benefit of U.S. Provisional Application No. 62/584,956 filed on Nov. 13, 2017, the contents of which are hereby incorporated by reference.

### TECHNICAL FIELD

The present disclosure relates generally to automated delivery and particularly to improved techniques for automated delivery.

### BACKGROUND

Typically, when goods are delivered from a place of origin to a destination, e.g., from a warehouse to a consumer, a package containing the goods is addressed to a person at a physical location to allow for an accurate and efficient delivery of the goods. While physical addresses are ubiquitous and easy to implement in practice, delivery using only a physical address can present several disadvantages. First, if the recipient is not present at the physical address at the time of delivery, the package may be left unattended, e.g., at a doorstop, where it may be misappropriated. Second, if a delivery person arrives at the location, but there no one able to sign for the package, the delivery policy of either the recipient or the deliverer may require the delivery person not to relinquish the package, and attempt delivery another day. This can obviously cause delay in delivery, which is frustrating to the recipient, as well as increase the delivery cost required by a second trip, which is detrimental to the delivery company. It would therefore be useful to solve these problems, and increase the efficiency with which deliveries are performed.

It would therefore be advantageous to provide a solution that would overcome at least the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for package delivery to a dynamic delivery location, including: receiving package information, where the package information includes at least a user device identifier; receiving location information from a user device based on the user device identifier; and sending delivery instructions to a delivery vehicle for delivery of the package based on the received location information.

Certain embodiments disclosed herein also include a non-transitory computer readable medium having stored thereon instructions for causing a processing circuitry to perform a process, the process including: receiving package information, where the package information includes at least a user device identifier; receiving location information from a user device based on the user device identifier; and sending delivery instructions to a delivery vehicle for delivery of the package based on the received location information.

Certain embodiments disclosed herein also include a system for package delivery to a dynamic delivery location, including: a processing circuitry; and a memory, the memory containing instructions that, when executed by the processing circuitry, configure the system to: receive package information, where the package information includes at least a user device identifier; receive location information from a user device based on the user device identifier; and send delivery instructions to a delivery vehicle for delivery of the package based on the received location information.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a flowchart of a method for automated package delivery to a dynamic end location, according to an embodiment.

FIG. 2 is a network diagram of a dynamic location delivery control system, according to an embodiment.

FIG. 3 is block diagram of a dynamic location delivery control system, according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

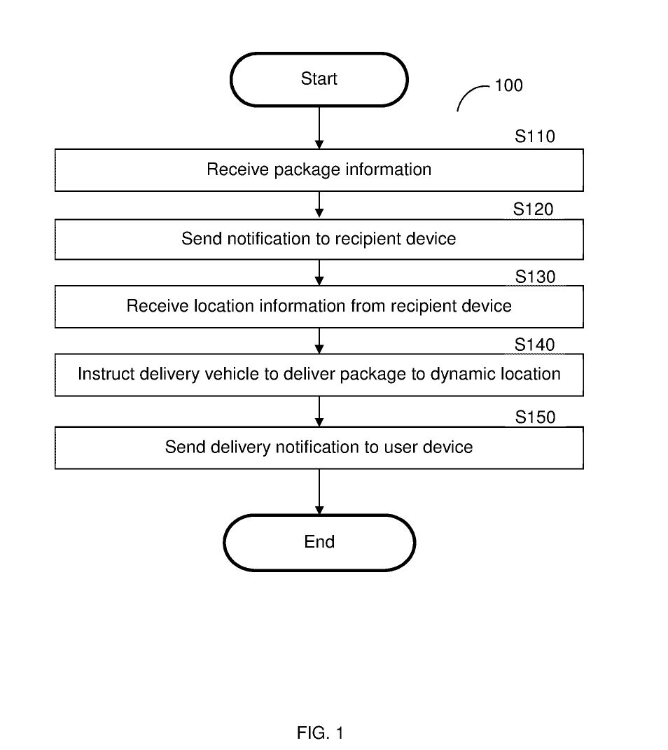

FIG. 1 is a non-limiting exemplary flowchart 100 of a method for automated package delivery to a dynamic end location, implemented in accordance with an embodiment. Automated delivery systems, such as drone delivery systems (i.e., systems utilizing unmanned aerial vehicles) may be used to deliver packages to a dynamic location. Typically, currently available solutions allow delivery only to static locations, such as a physical delivery address. However, delivery to a dynamic location allows for a recipient to be not restricted to a single delivery location, which can be selected by the sender without assessing the preference of the recipient, and is therefore preferable in certain situations.

At S110, a delivery control system receives package information pertaining to a package. The information may include: sender data, such as the name of the sender and an origin address; sender user device identifier; package metadata, such as size, weight, and contents; and recipient data, such as an associated user device identifier, name of the recipient, and the like. A user device identifier may be a unique identifier, e.g., a phone number, an IMSI number, an IMEI number, an email address, a username, and the like. In some embodiments, the package information may include a physical location destination (e.g., a physical recipient address).

At S120, a notification is sent to the recipient user device based on the received package information. The notification may include package information, such as the package metadata. The notification further includes, in certain embodiments, a request to approve delivery to a dynamic location. In some embodiments, where the request is denied, the user device may supply a physical location, e.g., an address, for delivery of the package as an alternative to a dynamic location.

At S130, location information is received from the recipient user device. The location information may include location coordinates, for example a Global Positioning System (GPS) location coordinates associated with the user device, e.g., a mobile phone, or GPS location coordinates associated with a secondary user device, e.g., a smartwatch. In certain embodiments, upon approval from the user device, and in response to a server request, the recipient user device may periodically provide location information. For example, the recipient user device may send a set of GPS coordinates every predefined period of time, or in response to entering or leaving a geo-fenced area.

At S140, an automated delivery vehicle is instructed to a deliver package to a dynamic delivery location. Instructions may include a generated navigation plan, which may include step by step directions to travel from a point of origin to a destination, e.g., based on the location information provided by the user device. In an embodiment, the instructions are formulated to be executed via a drone vehicle. The dynamic location may be continuously determined based on constantly, or periodically, updated location information received from the recipient user device. A generated navigation plan may be updated in response to received changes in the dynamic location.

In certain embodiments, predefined delivery locations may be predetermined. The delivery control system may determine one or more predefined delivery locations in proximity to the location of the user device. For example, if a user is located at various locations within a single building over a period of time, a single predetermined delivery location may be set as the destination for any user device location within that building. In an embodiment, the one or more predefined locations may be sent to the recipient user device, which may then send the delivery control system a selection of one of the predefined locations. The delivery control system may further provide the user device an estimated time of arrival to each of the one or more predefined locations.

In some embodiments, a dynamic location delivery control system may request access to a digital calendar of the user. The digital calendar may include data structures describing meetings, and a meeting may include a location. Based on future locations, i.e., locations which the user will be present at in a future time according to the digital calendar, the delivery control system may suggest delivery time and dynamic delivery locations to the user device.

At optional S150, a delivery notification is sent to the user device indicating delivery information. The delivery notification may indicate where a delivery may be retrieved, the estimated time of delivery, a request for permission to deliver a package to one of multiple delivery locations, and the like. In one embodiment, the notification is merely informative, and the delivery location is already established based on the location information retrieved from the user device.

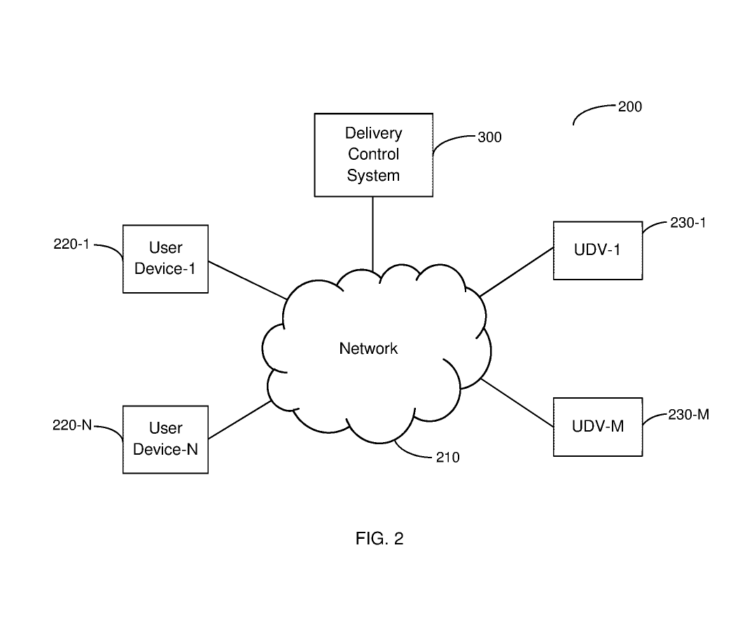

FIG. 2 is a network diagram 200 of a dynamic location delivery control system, implemented in accordance with an embodiment. A delivery control system 300 is communicatively coupled with a network 210. In an embodiment, the network 210 may be configured to provide connectivity of various sorts, as may be necessary, including but not limited to, wired or wireless connectivity to, for example, a local area network (LAN), a wide area network (WAN), a metro area network (MAN), the worldwide web (WWW), the Internet, and any combination thereof, as well as to cellular connectivity. The network may further provide various connectivity to a plurality of user devices 220-1 through 220-N, and a plurality of unmanned delivery vehicles (UDV) 230-1 through 230-M, where ‘N’ and ‘M’ are integers equal to or greater than 1. An unmanned delivery vehicle may be an aerial, nautical, or a ground vehicle. A user device 220 may be, for example, a mobile phone, a tablet, a personal computer, wearables, and the like. Any user device 220 may be a sender device, or a recipient device.

The delivery control system 300 is configured to receive package information pertaining to a package to be delivered. The information may include: sender data, such as name; sender user device identifier; package metadata, such as size, weight, and contents; and recipient data, such as an associated user device identifier, the name of the recipient, and the like. The user device identifier may be a unique identifier, such as a phone number, an IMSI number, an IMEI number, an email address, a username, and the like. In some embodiments, the delivery control system may store therein identifying information which is associated with a username. For example, the information may include only a username, which can be matched to a phone number, through which a recipient device may be contacted by the delivery control system to determine a dynamic delivery location.

The delivery control system 300 is configured to generate a navigation plan for an UDV 230 based on location information received from a recipient user device, such as user device 220-1. A navigation plan is typically generated by the delivery control system 300 before an unmanned delivery vehicle 230 is deployed. However, the delivery control system 300 may dynamically update the navigation plan according to received location information, for example in response to receiving the location information periodically or continuously.

In an exemplary embodiment, a sender user device may request to deliver a package to a recipient. The sender user device request includes an identifier of the recipient, such as a recipient username. A delivery control system 300 may cross reference the username in a user database stored thereon, or accessible thereto, which contains metadata associated with a user. This may provide an additional layer of security where it is advantageous, as the sender is not aware of any information which may identify a user, such as phone number and home or work address, and therefore the sender cannot compromise such information, and cannot use it for other purposes. In this example, the username may be cross referenced with a phone number and one or more user devices.

The delivery control system 300 may send the one or more user devices 220 a request to deliver the package. In some embodiments, the delivery control system 300 may designate one of the one or more user devices 220 as a recipient user device. The request to deliver the package may also include a request to the user device 220 to send the delivery control system 300 a preference for delivering to a dynamic delivery location, as defined herein. The delivery control system 300 may then dispatch a UDV 230 with the package to a dynamic delivery location, based on a received location of the recipient user device 220.

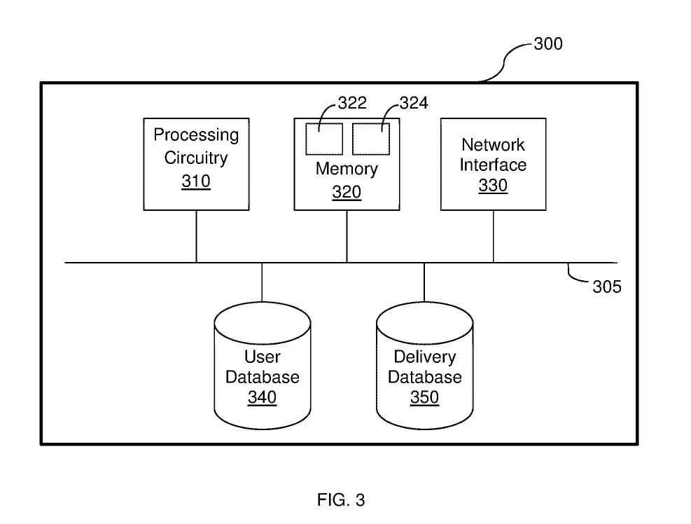

FIG. 3 is a block diagram of a dynamic location delivery control system 300 implemented according to an embodiment. The system 300 includes at least one processing circuitry 310, for example, a central processing unit (CPU). In an embodiment, the processing circuitry 310 may be, or be a component of, a larger processing unit implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing circuitry 310 is coupled via a bus 305 to a memory 320. The memory 320 may include a memory portion 322 that contains instructions that, when executed by the processing circuitry 310, performs the method described in more detail herein. The memory 320 may be further used as a working scratch pad for the processing circuitry 310, a temporary storage, and others, as the case may be. The memory 320 may be a volatile memory such as, but not limited to, random access memory (RAM), or non-volatile memory (NVM), such as, but not limited to, flash memory. The memory 320 may further include a memory portion 324 containing one or more delivery requests, where each delivery request is associated with one or more user identifiers and one or more package identifiers.

The processing circuitry 310 may be coupled to a network interface controller (NIC) 330, configured to allow for a connection to a network, such as the network 210 of FIG. 2. The processing circuitry 310 may be further coupled with a user database 340. The user database 340 may include a plurality of user entries, where each user entry is associated with one or more unique identifiers for a user, such as a user device name, a network address, a physical address, a phone number, an IMEI number, an IMSI number, an email address, and the like.

The processing circuitry 310 may be further coupled with a delivery database 350. The delivery database 350 may include a plurality of delivery entries, where each delivery entry corresponds to one or more packages, and corresponding package metadata. Package metadata may include, for example, weight, volume, dimensions, and the like of one or more delivery objects. In some embodiments, the delivery database 350 may further include stock keeping units (SKUs) for various items which may be delivered using the delivery control system 300. A package may include one or more SKUs, where each SKU corresponds to a single item. Any database, or additional storage, may be used for the purpose of storing a copy of the method executed in accordance with the disclosed technique.

The processing circuitry 310 or the memory 320 may also include machine-readable media (not shown) for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions cause the processing circuitry to perform the various functions described in further detail herein.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for package delivery to a dynamic delivery location, comprising:
receiving package information of a package, where the package information includes at least a user identifier;
receiving location information from a user device associated with the user identifier; and
sending navigation instructions to an automated delivery vehicle for delivery of the package based on the received location information.

2. The method of claim 1, wherein the package information includes at least one of: sender data, package metadata, and recipient data.

3. The method of claim 1, wherein the location information includes Global Positioning System (GPS) coordinates of the user device.

4. The method of claim 3, wherein updated GPS coordinates are periodically received from the user device over a period of time.

5. The method of claim 1, wherein sending the navigation instructions includes generating a navigation plan having step by step directions for the automated delivery vehicle to reach the dynamic delivery location.

6. The method of claim 1, wherein the automated delivery vehicle is an unmanned aerial vehicle (UAV).

7. The method of claim 1, further comprising:
determining a predefined location in proximity to the location of the user device based on the received location information.

8. The method of claim 1, further comprising: sending the user device a notification indicating delivery information.

9. The method of claim 8, wherein the delivery information includes at least one of: a location where a delivery may be retrieved, an estimated time of delivery, a request for permission to deliver the package to one of multiple delivery locations, and a request to approve delivery to a dynamic location.

10. A non-transitory computer readable medium having stored thereon instructions for causing a processing circuitry to perform a process, the process comprising:
receiving package information of a package, where the package information includes at least a user identifier;
receiving location information from a user device associated with the user identifier; and
sending navigation instructions to an automated delivery vehicle for delivery of the package based on the received location information.

11. A system for package delivery to a dynamic delivery location, comprising:
a processing circuitry; and
a memory, the memory containing instructions that, when executed by the processing circuitry, configure the system to:
receive package information of a package, where the package information includes at least a user identifier;
receive location information from a user device associated with the user identifier; and
send navigation instructions to an automated delivery vehicle for delivery of the package based on the received location information.

12. The system of claim 11, wherein the package information includes at least one of: sender data, package metadata, and recipient data.

13. The system of claim 11, wherein the location information includes Global Positioning System (GPS) coordinates of the user device.

14. The system of claim 14, wherein updated GPS coordinates are periodically received from the user device over a period of time.

15. The system of claim 11, wherein the system if further configured to:
generate a navigation plan having step by step directions for the delivery vehicle to reach the dynamic delivery location.

16. The system of claim 11, wherein the automated delivery vehicle is an unmanned aerial vehicle (UAV).

17. The system of claim 11, wherein the system is further configured to:
determine a predefined location in proximity to the location of the user device based on the received location information.

18. The system of claim 11, wherein the system is further configured to:
send the user device a notification indicating delivery information.

19. The system of claim 18, wherein the delivery information includes at least one of: a location where a delivery may be retrieved, an estimated time of delivery, a request for permission to deliver the package to one of multiple delivery locations, and a request to approve delivery to a dynamic location.
